(19) United States
(12) Patent Application Publication
(10) Pub. No.: US 2025/0113090 A1
(43) Pub. Date: Apr. 3, 2025

(54) ELECTRO-OPTICAL OBSERVATION DEVICE

(71) Applicant: Carl Zeiss AG, Oberkochen (DE)

(72) Inventors: Dennis Meyer, Oberkochen (DE); Joachim Welker, Oberkochen (DE)

(21) Appl. No.: 18/900,866

(22) Filed: Sep. 29, 2024

(30) Foreign Application Priority Data
Sep. 29, 2023 (DE) 10 2023 209 625.0

(51) Int. Cl. H04N 23/11; H04N 23/51; H04N 23/53

(52) U.S. Cl. CPC H04N 23/11; H04N 23/51; H04N 23/53

(57) ABSTRACT

An electro-optical observation device includes a device housing, a lens group arranged in the device housing, and a display unit arranged in the device housing and being configured to display a captured image or overlay information on a beam path. Moreover, the observation device includes an eyepiece arranged on an exit side with respect to the display unit and including at least one electrically conductive element, and a control device. The control device is in contact with the electrically conductive element and configured to form a capacitive proximity sensor with the electrically conductive element and control the display unit based on a measured quantity ascertained with the capacitive proximity sensor.

### CROSS REFERENCE TO RELATED APPLICATIONS

This application claims priority to German patent application DE 10 2023 209 625.0, filed Sep. 29, 2023, the entire content of which is incorporated herein by reference.

### TECHNICAL FIELD

The disclosure relates to an electro-optical observation device, for example a thermal imaging device or a night-vision device.

### BACKGROUND

Optical observation devices are used, inter alia, for observing nature and animals and also (e.g., also in this context) for hunting. Such observation devices are often binoculars or spotting scopes (the latter are commonly also referred to as “telescopes”). In the case of electro-optical observation devices, the functional scope thereof is often extended in order that “phenomena” outside the visual spectral range or below a brightness required for the human eye are made accessible to a user. In particular, mention may be made here of the representation of heat signatures and/or residual-light-intensified images which make it possible to observe objects even in (in particular subjective) darkness. Such functions are usually used in thermal imaging devices or else in night-vision devices. In this case, usually in a departure from purely optical observation devices the incident radiation is passed on to a person using the observation device (for short: a user) not by optical means but rather indirectly via image converter equipment (also: image sensor, photodetector or also (micro-) bolometers in the case of thermal imaging devices). In such cases, therefore, the image that can be viewed by the user is usually a display created on the basis of the incident radiation and usually after processing (image processing) has been carried out.

In the case of modern electro-optical observation devices, the user usually has the option to adapt the—often electronically created—display at least in part to said user's requirements, e.g., a brightness, a contrast, a magnification factor or the like. In this case, in a manner similar to that in the case of a camera, the user can often select and vary settings (usually formed by variable parameters) on the basis of a menu represented within the display. For this purpose, pushbuttons used for menu navigation, in particular for selecting and adapting the settings, are usually arranged on the observation device.

Electro-optical observation devices are usually battery-operated, and so an operation that is as energy efficient as possible is advantageous.

### SUMMARY

It is an object of the disclosure to improve the operation of an electro-optical observation device.

The object is achieved by an electro-optical observation device as described herein.

The electro-optical observation device according to an aspect of the disclosure includes a device housing and a lens group arranged in the device housing, especially on the entrance or object side. According to another aspect of the disclosure, the electro-optical observation device also includes an image capturing unit arranged in the device housing on the image side with respect to the lens group. Moreover, the electro-optical observation device includes a display unit arranged in the device housing and serving to display a captured image (captured with the image capturing unit in particular) or overlay information on a beam path (in particular of the lens group or a further lens group), and also an eyepiece arranged on the exit side with respect to the display unit. Moreover, this eyepiece includes at least one electrically conductive element. Furthermore, the electro-optical observation device includes a control device which is in contact with the electrically conductive element and configured to form a capacitive proximity sensor with the electrically conductive element and control the display unit on the basis of a measured quantity ascertained with the capacitive proximity sensor.

According to an aspect of the disclosure, the control device is configured to deactivate the display unit, i.e., for example, to switch it off or put it into a sleep mode with reduced power consumption, should the ascertained measured variable (in particular a capacitance measured variable) indicate a non-presence (absence) of a user of the electro-optical observation device in front of the eyepiece, especially within a given distance range. According to another aspect of the disclosure, the control device is also configured to (re-)activate the display unit in corresponding converse fashion should the measured quantity indicate the presence of the person, in particular an (optionally renewed) approach of the said person into the given distance range or a second given distance range.

According to an aspect of the disclosure, the control device is configured to compare the above-described measured quantity with at least one limit value which is characteristic for a given distance from the eyepiece. Should the measured quantity exceed the limit value in this context, the control device is configured to infer the presence of the user or, conversely, their departure from the distance range in front of the eyepiece, which is described by the specified distance (e.g., in the style of a radius of a circle or portion of a circle, for example semicircle).

Advantageously, this design of the electro optical observation device allows an energy-efficient operation. This is because it has been identified that the control of the display unit in a manner dependent on the measured quantity ascertained with the proximity sensor allows an automatic and use-dependent operation. Thus, energy can advantageously be saved in the case of non-use. Likewise, emergence of light from the eyepiece—due to the display of the captured image by the display unit—can be avoided should the electro-optical observation device be momentarily unused, for example if the latter is a night-vision or thermal imaging device.

Here and hereinafter, the phrase “exceeding a limit value” should always be understood to be independent of direction, in the sense that the difference between the measured quantity (or its change over time) and the limit value changes sign. Depending on the definition of the measured quantity, exceeding the limit value can be positive (in the sense of truly exceeding, within the scope of which the measured quantity becomes larger than the limit value) or negative (in the sense of dropping below, within the scope of which the measured quantity becomes smaller than the limit value).

Here and hereinafter, characteristic means that, in particular, the measured quantity contains not only quantitative information about the magnitude of the respective capacitance such that the capacitance can be derived unambiguously from the measured quantity, but also that the measured quantity thus also contains, at least indirectly, quantitative information about a distance between the electrically conductive element and a further object, especially the user. For example, the limit value specifies a value for the measured quantity—optionally based on empirical data—corresponding to a specific distance.

According to an aspect of the disclosure, at least two limit values are used in order to reproduce a hysteresis. In this context, the limit values are advantageously chosen to be so different that flickering as a result of repeated deactivation and activation of the display unit is avoided when the measured quantity fluctuates “to a small extent” about the limit value (especially if only one limit value is present). For example, the limit value for deactivation is chosen such that the latter is assigned a larger distance of the user than the limit value for (re-)activation. For example, the limit value for deactivation can be assigned a distance 2 to 15 cm larger than the distance for (re-)activation. For example, the control device is in this case configured to deactivate the display unit should the measured quantity indicate no user presence within the (first) distance range of 15 cm in front of the eyepiece (in this case, the limit value is for example specified to be 15 cm) and reactivate said display unit should the measured quantity indicate a presence within the second distance range of less than or equal to 8 cm (in this case, the further limit is for example specified to be 8 cm).

Optionally, the control device is configured to also deactivate or else reactivate the image capturing unit (and optionally further electrical loads as well, if applicable, apart from the control device and the proximity sensor itself) in addition to the display unit—or else perform this alternatively within the scope of an independent disclosure—should the ascertained measured quantity indicate the non-presence (absence) or presence (in particular renewed presence) of the user in front of the eyepiece.

Particularly typically, the electrically conductive element, which forms the capacitive proximity sensor together with the control device and represents the capacitive sensor electrode of the proximity sensor in particular, is an element present on the electro-optical observation device in any case, i.e., an element present independently of the electro-optical observation device being equipped with the proximity sensor. This can keep additional material outlay as small as possible. According to an aspect of the disclosure, a design of the electro-optical observation device (as visible from the outside) need not be modified either.

According to an exemplary embodiment, the electrically conductive element is a housing component of the electro-optical observation device. According to an aspect of the disclosure, this housing component is formed from a metal—e.g., aluminum, steel or an alloy made of one of these metals—or provided with a metallic coating.

For example, the housing component is a screw, a lens mount, a spacer ring (which is interchangeable) or a seal carrier. For example, the latter serves to keep sealing bellows serving to contact the face of the user around the eye in shape and/or against the housing.

According to an alternative exemplary embodiment, the electrically conductive element is a functional coating of a lens or cover plate of the eyepiece. Lenses are regularly provided with coatings in order to suppress or reduce reflections and/or increase a transmission through the lens. A cover plate serving as a protection against contamination or mechanical impact for optical component parts (i.e., typically lenses) arranged behind the cover plate and hence within the device housing can also be provided with such coatings, and optionally with an antifog coating as well. Some such coatings also include electrically conductive materials, which nevertheless appear transparent on account of their application and/or chemical bonding. According to the embodiment described here, such a layer is typically galvanically contacted such that this coating can be used as a capacitive sensor electrode.

According to an optional embodiment, the control device (also referred to as a controller) is formed as a non-programmable (application-specific) electronic circuit (“ASIC”), or includes such a circuit, with which the capacitive proximity switch is formed. In particular, the electrically conductive element of the eyepiece is connected to this circuit, typically by galvanic contacting. For example, such a circuit forms a dedicated sensor circuit of the control device which additionally also includes other component parts in the form of further ASICs or microcontroller(s)—for other control tasks.

According to an alternative exemplary embodiment, the control device includes a microcontroller, integrated in which is the functionality for forming the capacitive proximity sensor, for example by way of a software module. Expediently, the electrically conductive element is then connected to this microcontroller.

According to an exemplary embodiment, the electro-optical observation device includes at least one shielding element for shaping an electric field that is emitted by the electrically conductive element during the intended use (of the capacitive proximity sensor in particular). According to an aspect of the disclosure, this shielding element is formed as an electrode (i.e., made of electrically conductive material), which is at a reference potential (e.g., at “ground” or a so-called “floating ground”). According to another aspect of the disclosure, the shielding element is configured, especially geometrically shaped, such that the electric field is directed in the direction of the expected approach. For example, the above-described spacer ring can form this field shaping electrode, especially if the coating or the lens mount forms the sensor electrode. For example, this spacer ring can surround the lens(es) like a ring such that an electric field spread radially to the optical axis can easily be suppressed.

In principle, it can be conceivable within the scope of the disclosure that the display unit is configured and provided to project a light spot or the like into the beam path-especially within the scope of a telescopic sight. In telescopic sights, such a light spot is used as support means for a so-called reticle (commonly also referred to as “crosshairs”, independently of the actual design in particular).

However, the electro-optical observation device is in the form of a thermal imaging device or night-vision device according to a further exemplary embodiment. In the case of thermal imaging devices, the observation device includes what is known as a microbolometer array as the above-described image capturing device. In the case of night-vision devices, the observation device typically includes a residual light amplifier as the image capturing device. In both cases, the display unit is conventionally formed by a display which displays the image captured and output with the microbolometer array or residual light amplifier. In turn, this image is output (displayed) to the user, at least with the eyepiece.

Here and hereinafter, the conjunction “and/or” should be understood to mean in particular that the features linked by this conjunction can be embodied both jointly and as alternatives relative to one another.

### BRIEF DESCRIPTION OF THE DRAWINGS

The disclosure will now be described with reference to the drawings wherein:

FIG. 1 shows a schematic side view of an electro-optical observation device, and

FIG. 2 shows a view of the electro-optical observation device in accordance with FIG. 1 according to an alternative exemplary embodiment of the disclosure.

### DESCRIPTION OF EXEMPLARY EMBODIMENTS

Mutually corresponding parts are provided with the same reference signs throughout the figures.

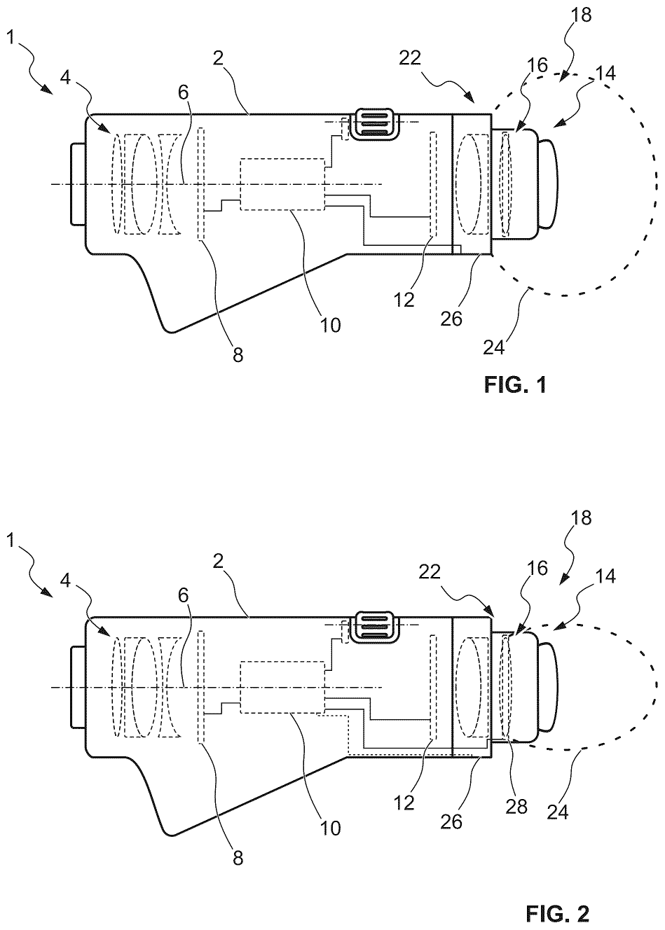

FIG. 1 schematically illustrates an electro-optical observation device, here specifically a thermal imaging spotting scope (for short: thermal imaging device 1). The thermal imaging device 1 includes a handheld device housing (for short: housing 2). An entrance-side lens group 4 and, downstream in a “radiation transmission direction 6”, an image capturing unit in the form of an image sensor 8 (also: image converter) are arranged in the housing 2. The image sensor 8 is coupled to a control device (referred to here as “controller 10”) in terms of signal transmission. The controller 10 is coupled on the output side to an (image) display unit, here in the form of a display 12, and is configured to process an image received with the image sensor 8 and to output said image in processed form to the display 12 for the purpose of being displayed. Furthermore, the thermal imaging device 1 includes an eyepiece 14 (and, as illustrated in the exemplary embodiment, optionally a “second” lens group 16 assigned to the eyepiece 14), through which a user can view the processed and displayed image. The display 12, the eyepiece 14 and the lens group 16 form an electronic viewfinder 18.

Furthermore, the thermal imaging device 1 includes a proximity sensor 22, which is arranged in the region of the eyepiece. With the proximity sensor 22, the controller 10 is configured to monitor a distance region 24, which is arranged outside of the housing 2 (e.g., approximately 4 cm) around the viewfinder 18, specifically in front of the eyepiece 14, for the presence of an object, especially a person, specifically a user of the thermal imaging device 1.

The proximity sensor 22 is configured as a capacitive proximity sensor. However, in order to be able to save component parts in this case, a capacitive sensor electrode of the proximity sensor 22 is formed by a metallic housing component of the thermal imaging device 1 in the exemplary embodiment according to FIG. 1. In this case, the housing component is a spacer ring 26 of the eyepiece 14. This spacer ring 26 is coupled to the controller 10 in terms of signal transmission. Optionally, the controller 10 includes an application-specific circuit (ASIC), which realizes the circuit of the proximity sensor 22 and the signal evaluation. Alternatively, the proximity sensor control is integrated in a microcontroller of the controller 10.

FIG. 2 illustrates an alternative exemplary embodiment. In this case, a metallic lens mount 28 of the second lens group 16 serves as sensor electrode of the proximity sensor 22 and is consequently in contact with the controller 10. In an optional variant, the spacer ring 26 is used here as a shielding electrode in order to shape the electric field that is emitted by the lens mount 28 during the intended use and for example exclude from the approach detection regions around the housing 2 adjacent to a hand of the user even if the thermal-imaging device 1 is only carried but not actively used. To this end, the spacer ring 26 is also in contact with the controller 10, in particular placed at a reference potential of the controller 10 (see the dashed connecting line in FIG. 2).

The controller 10 is configured (in both illustrated exemplary embodiments) to activate the display 12 during the intended operation only if the user of the thermal imaging device 1 can be assumed to be guiding the latter to in front of their eye, this assumption being based on a measured quantity—for example a capacitance with a specific value—output by the proximity sensor 22. To this end, the controller 10 compares the measured quantity with a limit value that represents a value of the measured quantity (capacitance) assigned to the distance given by the distance range 24. If the current value of the measured quantity exceeds the limit value in the process, to the effect that the value of the measured quantity becomes larger than the limit value, then the controller 10 infers an absence of the user in the distance range 24 and controls the display 12 to transition into an inactive state. Expressed differently, the controller 10 switches the display 12 off. Conversely, however, the controller 10 correspondingly activates the display if the value of the measured quantity becomes smaller than the limit value since the controller 12 then infers that the user is approaching the eyepiece 14 and thus wishes to use the thermal imaging device 1 for observation purposes.

The subject matter of the disclosure is not restricted to the exemplary embodiments described above. Rather, further embodiments of the disclosure can be derived from the above description by a person skilled in the art. In particular, the individual features of the disclosure described with reference to the various exemplary embodiments and the design variants thereof can also be combined with one another in a different way.

### LIST OF REFERENCE NUMERALS

1 Thermal imaging device
2 Housing
4 Lens group
6 Radiation transmission direction
8 Image sensor
10 Controller
12 Display
14 Eyepiece
16 Lens group
18 Viewfinder
22 Proximity sensor
24 Distance range
26 Spacer ring
28 Lens mount

What is claimed is:

1. An electro-optical observation device, comprising
a device housing;
a lens group arranged in the device housing;
a display unit arranged in the device housing and configured to display a captured image or overlay information on a beam path;
an eyepiece arranged on an exit side with respect to the display unit and including at least one electrically conductive element; and
a control device in contact with the electrically conductive element and configured to:
form a capacitive proximity sensor with the electrically conductive element, and
control the display unit based on a measured quantity ascertained with the capacitive proximity sensor.

2. The electro-optical observation device as claimed in claim 1,
wherein the electrically conductive element is a housing component.

3. The electro-optical observation device as claimed in claim 2,
wherein the housing component is formed from a metal or provided with a metallic coating.

4. The electro-optical observation device as claimed in claim 2,
wherein the housing component is a screw, a lens mount, a spacer ring or a seal carrier.

5. The electro-optical observation device as claimed in claim 1,
wherein the electrically conductive element is a glass coating of a lens or cover plate.

6. The electro-optical observation device as claimed claim 1,
wherein, to form the capacitive proximity sensor, the control device includes an application-specific sensor circuit connected to the electrically conductive element.

7. The electro-optical observation device as claimed in claim 1,
wherein the control device includes a microprocessor, to which the electrically conductive element is connected to form the capacitive proximity sensor.

8. The electro-optical observation device as claimed in claim 1, further comprising at least one shielding element configured to shape an electric field emitted by the electrically conductive element.

9. The electro-optical observation device as claimed in claim 1,
wherein the control device is configured to deactivate the display unit when the measured quantity indicates an absence of a user from a given distance range in front of the eyepiece.

10. The electro-optical observation device as claimed in claim 1, wherein the electro-optical observation device is embodied as a thermal imaging device or as a night-vision device.
